(19) United States
(12) Patent Application Publication
(10) Pub. No.: US 2026/0203913 A1
(43) Pub. Date: Jul. 16, 2026

(54) IMAGE PROCESSING APPARATUS, IMAGE PROCESSING METHOD, AND COMPUTER PROGRAM FOR EXECUTING THE METHOD

(71) Applicant: CANON KABUSHIKI KAISHA, Tokyo (JP)

(72) Inventor: Kenshi SAITO, Kanagawa (JP)

(21) Appl. No.: 19/422,595

(22) Filed: Dec. 17, 2025

(30) Foreign Application Priority Data
Jan. 16, 2025 (JP) 2025-006344

(51) Int. Cl. G06T 7/20; G06V 10/74; G06V 10/77; G06V 10/82

(52) U.S. Cl. CPC G06T 7/20; G06V 10/761; G06V 10/7715; G06V 10/82; G06V 2201/07

(57) ABSTRACT

An image processing apparatus comprises an image acquisition unit that acquires input images in chronological order, a subject detection unit that generates, from the input images, information related to a subject region of a tracking subject as subject region information, a similar region detection unit that generates, from the input images, information related to one or more similar regions being regions of a subject similar to the tracking subject as similar region information, and a storage unit that stores the subject region information and the similar region information. The subject detection unit generates the subject region information by using the subject region information of past frames and the similar region information of past frames that are stored in the storage unit. In addition, the subject detection unit and the similar-region detection unit are configured by neural networks.

### BACKGROUND

### Field of the Technology

The present disclosure relates to an image processing apparatus, and particularly to an image processing apparatus that is suitable for accurately tracking a specific subject in an image while suppressing the amount of computation in tracking the subject.

### Description of the Related Art

In recent years, image processing technologies have been utilized in various fields such as monitoring systems, autonomous vehicles, and sports analysis, and, in particular, technologies for tracking a specific subject in a moving image have played an important role. Additionally, with the advancement of image processing technologies, there has been a demand in the fields of surveillance cameras, robotics, and video analysis for technologies capable of efficiently and accurately tracking a specific subject in an image.

Conventionally, methods utilizing luminance or color information and template matching have been known as technologies for tracking a specific subject in an image. In contrast, in recent years, methods utilizing Deep Neural Networks (hereinafter simply referred to as “DNNs”), which are a type of deep learning, have attracted attention as highly accurate tracking technologies.

For example, Luca Bertinetto et al., “Fully-Convolutional Siamese Networks for Object Tracking,” [online], June 30, 2016, [searched on December 25, 2024 (Reiwa 6)], arXiv, Internet: https://arxiv.org/pdf/1606.09549 , describes a method for tracking a specific subject in an image. In the method described in this document, an image in which a tracking subject appears and an image serving as a search area are respectively input to Convolutional Neural Networks (hereinafter simply referred to as “CNNs”) having identical weights. Then, by calculating a cross-correlation between feature values obtained therefrom, the position of the tracking subject existing in the search area image is specified. Recently, a Vision Transformer (Alexey Dosovitskiy et al., “An Image is Worth 16×16 Words: Transformers for Image Recognition at Scale,” [online], October 22, 2020, [searched on December 25, 2024 (Reiwa 6)], arXiv, Internet: https://arxiv.org/pdf/2010.11929) that applies the Transformer architecture to image recognition has been introduced, further improving the accuracy of image recognition. In this context, a Transformer is a deep learning model architecture characterized by the use of a self-attention mechanism to efficiently capture relationships among important parts within input data. Although such tracking methods can accurately identify the position of a tracking subject, they are likely to fail by tracking an incorrect subject in a case in which an object similar to the tracking subject overlaps on the screen.

In order to avoid this, as exemplified by the method disclosed in U.S. Patent Application Publication No. 2018/0012078, there is a method for improving tracking accuracy by creating a histogram based on color features and depth information of a detected object region, examining, for example, changes thereof, and determining whether the object is occluded. Additionally, Yuanyou Xu et al., “Integrating Boxes and Masks: A Multi-Object Framework for Unified Visual Tracking and Segmentation,” [online], August 25, 2023, [searched on December 25, 2024 (Reiwa 6)], arXiv, Internet: https://arxiv.org/abs/2308.13266 , describes a method for performing object tracking by individually inferring a region for each tracking subject using a DNN and tracking the object based on inference results obtained from past frames and image features.

In the method described by Yuanyou Xu et al., a map having a plurality of channels is stored over several past frames so that a plurality of tracking subjects can be tracked simultaneously. Therefore, transfer time for the map is added, and additional computation using the map as input is further required. Accordingly, this method has a problem in that the amount of computation tends to increase

### SUMMARY

An object of the present disclosure is to provide an image processing apparatus capable of accurately tracking a specific subject in an image while suppressing the amount of computation when tracking the subject.

The configuration of the image processing apparatus of the present disclosure is preferably such that the image processing apparatus comprises an image acquisition unit configured to acquire input images in chronological order, a subject detection unit configured to generate, from the input images, information related to a subject region of a tracking subject as subject region information, a similar region detection unit configured to generate, from the input images, information related to one or more regions that are regions of a subject similar to the tracking subject as similar region information, and a storage unit that stores the subject region information and the similar region information. The subject detection unit is configured to generate the subject region information by using the subject region information and the similar region information of past frames that have been stored.

Further features of the present disclosure will become apparent from the following description of exemplary embodiments (with reference to the attached drawings).

### BRIEF DESCRIPTION OF THE DRAWINGS

FIG. 1 is a functional configuration diagram of an image processing apparatus according to a first embodiment.

FIG. 2 is a diagram illustrating hardware and software configuration of the image processing apparatus.

FIG. 3 is a flowchart illustrating a series of processes for obtaining a subject region and a similar region associated with a tracking subject in the image processing apparatus according to the first embodiment.

FIG. 4 is a diagram illustrating a state in which a tracking subject is detected from an image.

FIG. 5 is a diagram illustrating a flow of processing related to a subject region and a similar region related to a tracking subject in the image processing apparatus according to the first embodiment.

FIG. 6 is a diagram illustrating a processing flow of learning related to a subject region and a similar region related to a tracking subject in the image processing apparatus according to the first embodiment.

FIG. 7 is a functional configuration diagram of an image processing apparatus according to a second embodiment.

FIG. 8 is a diagram illustrating a processing flow related to a subject region and a similar region associated with a tracking subject in the image processing apparatus according to the second embodiment.

FIG. 9 is a functional configuration diagram of an image processing apparatus according to a third embodiment.

FIG. 10 is a diagram illustrating a processing flow of learning related to a subject region and a similar region associated with a tracking subject in the image processing apparatus according to the third embodiment.

FIG. 11 is a diagram illustrating a flow of processing related to a subject region and a similar region associated with a tracking subject in an image processing apparatus according to a fourth embodiment.

### DESCRIPTION OF THE EMBODIMENTS

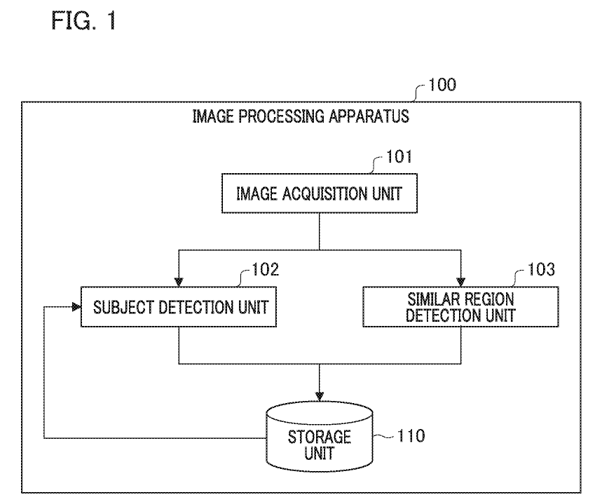

Hereinafter, respective embodiments according to the present disclosure will be explained with reference to FIG. 1 to FIG. 11.

### First Embodiment

Hereinafter, a first embodiment according to the present disclosure will be explained with reference to FIG. 1 to FIG. 6.

The present embodiment relates to an image processing apparatus that realizes a function of detecting and tracking a person from a moving image or continuously captured still-image frames (hereinafter, also simply referred to as “input images”). Although the scope of application of the present disclosure is not limited to the category of the object to be detected or tracked, in the present embodiment, an example in which the subject is a person will be explained. In a technology related to tracking of a person in the present embodiment, tracking of a person is realized by detecting the same person appearing in consecutive frames. In the state handled by the present embodiment, it is assumed in particular that shooting of a sports event and the like is performed, in which the clothing and moving directions of persons are similar and the persons frequently approach or cross each other. In such a case, erroneous tracking is likely to occur if a person having similar appearance features such as position and color between respective frames is regarded as the same person. In the present embodiment, a case in which a failure occurs in such tracking of a person is referred to as “erroneous tracking.”

In the present disclosure, attention is paid to an object having an appearance similar to that of a tracking subject so that the occurrence of such erroneous tracking is inhibited. Then, by using, for object tracking, information indicating a region in past frames in which the tracking subject and an object having an appearance similar to the tracking subject are present, the occurrence of erroneous tracking is suppressed, and tracking accuracy is improved.

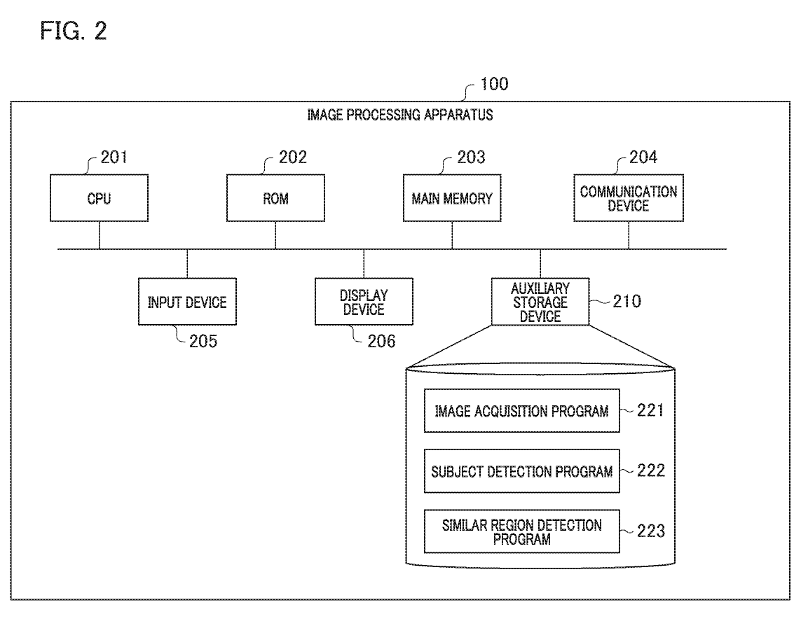

First, a configuration of the image processing apparatus according to the first embodiment will be explained with reference to FIG. 1 and FIG. 2.

FIG. 1 is a functional configuration diagram of the image processing apparatus according to the first embodiment.

FIG. 2 is a hardware and software configuration diagram of the image processing apparatus.

As shown in FIG. 1, the image processing apparatus according to the present embodiment is, as a functional configuration, configured by an image acquisition unit 101, a subject detection unit 102, a similar region detection unit 103, and a storage unit 110.

The image acquisition unit 101 is a functional unit that performs acquisition of input images. That is, the image acquisition unit 101 sequentially acquires from the storage unit 110 image frames of a moving image or consecutive still images in which a person has been imaged. Additionally, the image acquisition unit 101 has a function of acquiring specific information or a specific region from an image frame. It is to be noted that the image acquisition unit 101 may acquire, in addition to images from the storage unit 110, images captured by an imaging apparatus connected to the image processing apparatus 100 and images obtained from another external apparatus.

The subject detection unit 102 is a functional unit that detects a specific person and a region of the person based on an image acquired by the image acquisition unit 101, and based on similar region information and subject region information calculated from past frames along a time axis.

The similar region detection unit 103 is a functional unit that detects a region of a subject similar to the tracking subject. The similar region detection unit 103 can be implemented, for example, by a neural network.

The storage unit 110 is a functional unit that stores data and programs handled by the image processing apparatus.

As shown in FIG. 2, as hardware, the image processing apparatus 100 is configured by a CPU 201, a ROM 202, a main memory 203, a communication device 204, an input/output device 205, a display device 206, and an auxiliary storage device 210.

The Central Processing Unit (CPU) 201 controls respective units of the image processing apparatus and realizes functions by executing programs loaded into the main memory 203.

The Read Only Memory (ROM) 202 is a nonvolatile semiconductor storage device that stores programs such as firmware and BIOS that are not rewritable.

The main memory 203 is realized by a Random Access Memory (RAM) and is a volatile semiconductor storage device that temporarily stores programs and work data referenced by the CPU 201.

The communication device 204 is a device that connects the image processing apparatus 100 to a network and enables communication with other devices such as an imaging apparatus and a server.

The input/output device 205 includes a keyboard, a touch panel, a mouse, a printer, and the like, receives input from a user, and is used when a tracking subject is set and when information is output.

The display device 206 is, for example, a liquid crystal display and the like, and displays an image, a subject, and a tracking result to a user.

The auxiliary storage device 210 is, for example, a large-capacity storage device such as a hard disk drive (HDD) or a solid-state drive (SSD). In the auxiliary storage device 210 of the present embodiment, an image acquisition program 221, a subject detection program 222, and a similar region detection program 223 are installed. The image acquisition program 221 corresponds to the image acquisition unit 101, the subject detection program 222 corresponds to the subject detection unit 102, and the similar region detection program 223 corresponds to the similar region detection unit 103, and these programs are computer programs that realize functions of the corresponding units. Additionally, in the present embodiment, image data to be processed, setting data, and data indicating tracking results are stored. The image data include data of moving-image frames and still images arranged along a time-series, and metadata relating to a target object included in each frame (for example, photographing time and camera position). The setting data include an initial position and a size of a tracking subject, a category (for example, a person and a vehicle), and thresholds and learning parameters. As data indicating tracking results, there are detection coordinates of a tracking subject (for example, a position and a size of a bounding box), a label or an identifier of the tracking subject, and a list and feature quantities of similar regions. As a device that stores programs and data, an optical medium, a flash memory card, and the like may also be used as a medium of the auxiliary storage device 210, in addition to an HDD and an SSD.

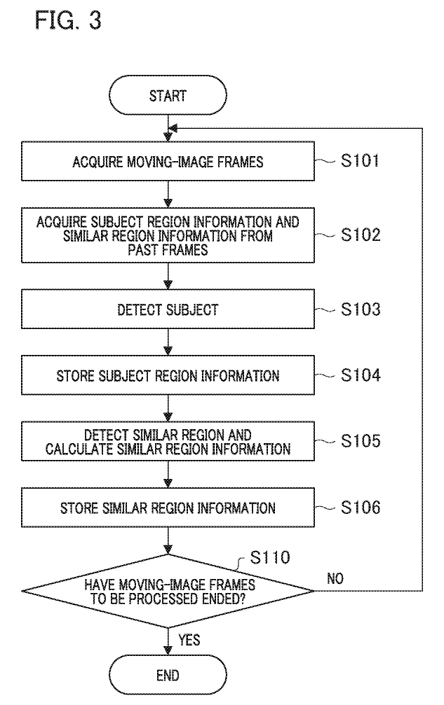

Next, a series of processes for obtaining a subject region and a similar region associated with a tracking subject of the image processing apparatus according to the first embodiment will be explained with reference to FIG. 3 to FIG. 5.

FIG. 3 is a flowchart illustrating a series of processes for obtaining a subject region and a similar region associated with a tracking subject of the image processing apparatus according to the first embodiment.

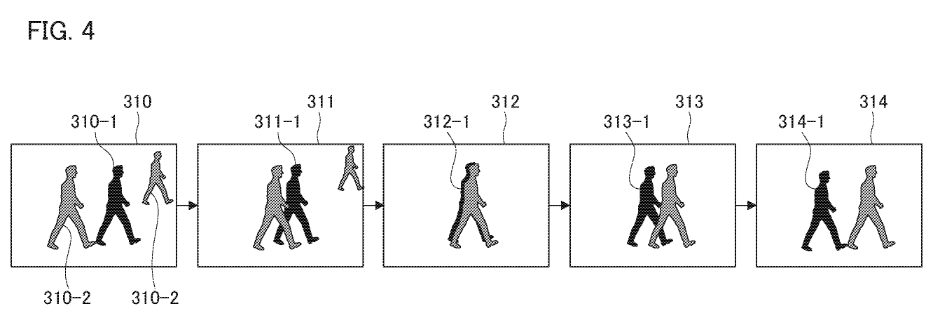

FIG. 4 is a diagram for explaining a state in which a tracking subject is detected from an image.

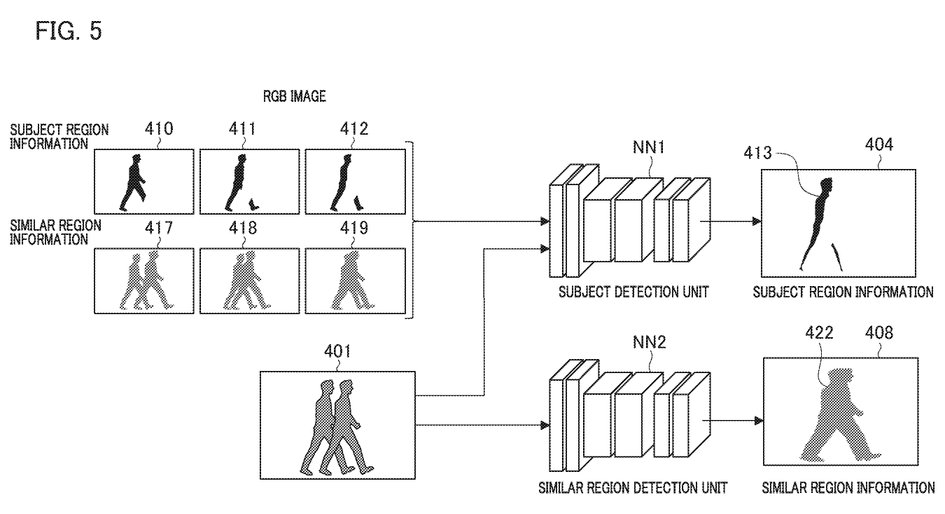

FIG. 5 is a diagram for explaining the flow of processing related to a subject region and a similar region associated with a tracking subject of the image processing apparatus according to the first embodiment.

The image acquisition unit 101 of the image processing apparatus 100 sequentially acquires image frames of a moving image or consecutive still images in which a person is imaged, and which are stored (S101).

Next, the image acquisition unit 101 acquires similar region information, which is information of a similar region calculated from past N (N is a natural number) frames, and subject region information of past N frames (S102). In this context, a similar region refers to a region of a subject similar to a tracking subject (details will be described below). In the present embodiment, explanation will be given with N = 3, although any number of frames may be used as long as it is one or more predetermined frames. However, the number N of frames corresponding to the similar region information and the subject region is fixed in advance at the time of learning and is not changed during calculation at the subject detection unit 102 and the similar region detection unit 103.

Next, the subject detection unit 102 of the image processing apparatus 100 detects a specific person and a region of the person based on an image acquired in steps S101 and S102, and based on similar region information and subject region information calculated from past N frames (S103). As a method of detecting an object from an image, any method may be used, for example, as a known technique, a method shown in Luca Bertinetto et al. can be cited.

Next, the subject detection unit 102 of the image processing apparatus 100 stores information related to the subject region detected in step S103 in the storage unit 110 (S104).

Next, the similar region detection unit 103 of the image processing apparatus 100 detects a similar region relating to a region of an object having features similar to those of the tracking subject and calculates similar region information (S105). It is to be noted that the calculation processing of the similar region information will be explained in detail below.

Next, the similar region detection unit 103 of the image processing apparatus 100 stores, in the storage unit 110, the similar region information calculated in step S105 (S106).

Next, the image processing apparatus 100 determines whether or not the processing of the moving-image frames to be processed has ended (S110), and when the processing has ended (S110: YES), ends the processing, and when the processing has not ended (S110: NO), returns to S101 and repeats the processing.

Next, processing for detecting a specific tracking subject from an image, and related concepts such as a similar region and similar region information, will be explained with reference to FIG. 4 and FIG. 5.

A state in which a specific tracking subject is detected from an image is illustrated in FIG. 4. In FIG. 4, an image 310, an image 311, an image 312, an image 313, and an image 314 are shown in time-series. In the image 310, an object region 310-1 and an object region 310-2 are detected, in the image 311, an object region 311-1 is detected, in the image 312, an object region 312-1 is detected, and in the image 313, an object region 313-1 is detected.

Here, in a case in which a person is the object, the object region is explained as a region including a head, a torso, limbs, and the like of the person serving as the tracking subject, as shown in the object region 310-1. However, as the tracking subject, only a part such as a torso may suffice, and the region is not limited to a region including the entire body.

In this context, a subject region is defined as an object region in a case in which the tracking subject is a person, as shown in the object region 311-1. Additionally, when the tracking subject is a person in the object region 311-1, a similar region is defined as an object region of a person having features similar to those of the tracking subject as shown in the object region 310-2, and similar region information is defined as information related to the similar region.

Similar region information serves as a target of learning and inference using the input RGB image 401 shown in FIG. 5 as input. It is to be noted that details of learning and inference of the similar region information will be explained below.

A similar region is, for example, if a person is the tracking subject, a region having features (a shape and a color), and may be the entire body of the person, as in the object region 301-2, or may be a part of the person (a head, a torso, and the like). In this case, the set of similar regions includes the subject region as well. That is, the subject region itself is regarded as the similar region, and the subject region information is used as similar region information. Thereby, an effect of facilitating learning and inference is obtained. Details will be explained below.

The detection of the subject region in step S103 of FIG. 3 is a type of recognition task of semantic region segmentation and can be realized by a known method, for example, Liang-Chieh Chen et al., “DeepLab: Semantic Image Segmentation with Deep Convolutional Nets, Atrous Convolution, and Fully Connected,” [online], June 2, 2016, [searched on December 25, Reiwa 6 (2024)], arXiv, Internet <URL: https://arxiv.org/pdf/1606.00915>. In Liang-Chieh Chen et al., a technology for specifying an object boundary using a deep convolutional network is described.

In FIG. 5, a state in which subject region information is calculated by the subject detection unit 102 is shown. A neural network NN1 that determines a region of a tracking subject is a mechanism having functions described in Liang-Chieh Chen et al. When the RGB image 401, subject region information 410, 411, and 412 of past N frames, and similar region information 417, 418, and 419 are input to the neural network NN1, the subject detection unit 102 detects where in the image a region corresponding to the person is located and outputs subject region information 413.

In contrast, the similar region detection unit 103 is configured by a neural network NN2 that determines a region similar to a tracking subject, and is likewise a mechanism having functions described in Liang-Chieh Chen et al. When the RGB image 401 is input, a region of a person similar to the tracking subject is detected and integrated, and similar region information 422 is output. In the present embodiment, the subject region information and the similar region information are calculated using a likelihood score, which is set to 0 in a case in which the region is estimated as a region of the object, and to 1 in other cases. In a case in which a region of a person similar to the tracking subject is directly output as a score, the detected map is defined as the similar region information 422. It is also conceivable that the detected results are features of H×W×C, and that the features are integrated, for example, by addition in the channel direction, to obtain the similar region information 422. However, in the case of a first moving-image frame, since there are no past frames, initial subject region information and initial similar region information are generated and input as the subject region information and similar region information of past N frames. Generation of initial subject region information and initial similar region information will be explained below. A neural network 402 has been trained in advance so as to output such outputs for an input image (learning of the subject region information and the similar region information will be described below). It is to be noted that, although the entire body of the tracking subject may be output as an estimation result in a case in which the subject region information is ideally output, actual results may include noise, such as in a case in which a part of the limbs is missing, as in the subject region information 413.

It is to be noted that, as the input image, in addition to the RGB image 401, a modified form is also conceivable in which a 2.5-dimensional depth image is separately acquired by using a dedicated sensor and the like. In this case, learning and recognition are performed by using, as the depth image input instead of the RGB image, four-channel information obtained by concatenating with the three-channel RGB image 401. As a result, the accuracy of occluded-region information can be improved.

Here, a generation method of the initial subject region information will be explained.

As initial subject region information to be input to the subject detection unit 102 at an initial frame, in a case in which region information of the tracking subject cannot be obtained, a map in which all values are zero is used. In other cases, in a case in which a subject region at a first moving-image frame can be obtained in advance, copies for N frames are generated and used as initial subject region information. As one example, a method for generating an initial subject region by using segmentation of a tracking subject at a first moving-image frame will be explained. Segmentation information of a tracking subject at a first frame is calculated in advance by a technology described in Alexey Dosovitskiy et al. and the like, and a map of obtained segmentation is copied for N frames. Then, the copied segmentation maps are input to the subject detection unit 102 as initial subject region information.

Next, a generation method of the initial similar region information will be explained.

The similar region information obtained by inputting an initial input image to the similar region detection unit 103 is copied for N frames (in the present embodiment, N = 3) and used as initial similar region information. When the subject detection unit 102 calculates subject region information from the initial frame, the initial frame, the initial subject region information generated by the above method, and the similar region information generated by this method are input to the subject detection unit 102.

Next, detection and inference of the subject region information and the similar region information will be explained.

In the present embodiment, the subject region information and the similar region information have been explained as estimating a visible region of an object. In particular, in the present embodiment, although the explanation has been given in the form of a region in which the entire body of a person is shown in different colors, the present disclosure is not limited thereto as long as information indicating where the subject exists is represented. For example, a map in which a value of 1 is assigned only to the torso and 0 to other regions may be used, or a map having a specific value in a vicinity where a tracking subject is located may be used. In addition, a map representing a central region of the object may be used. In this context, the central region of the object refers to a form that estimates a region represented by a Gaussian function.

The subject detection unit 102 is trained to infer subject region information for a region of a tracking subject. In contrast, the similar region detection unit 103 is trained to infer similar region information relating to a region of an object having features similar to those of the tracking subject, as executed in step S105. The similar features are learned so as to respond according to characteristics of an object that can be a tracking subject, such as whether or not the object has a shape similar to a person, whether or not the color is similar, or whether or not the posture is similar. Although the similar region information has been explained, similar to the subject region, as the entire body region of a similar person, the present disclosure is not limited to this format as long as information indicating in which region the subject exists is represented.

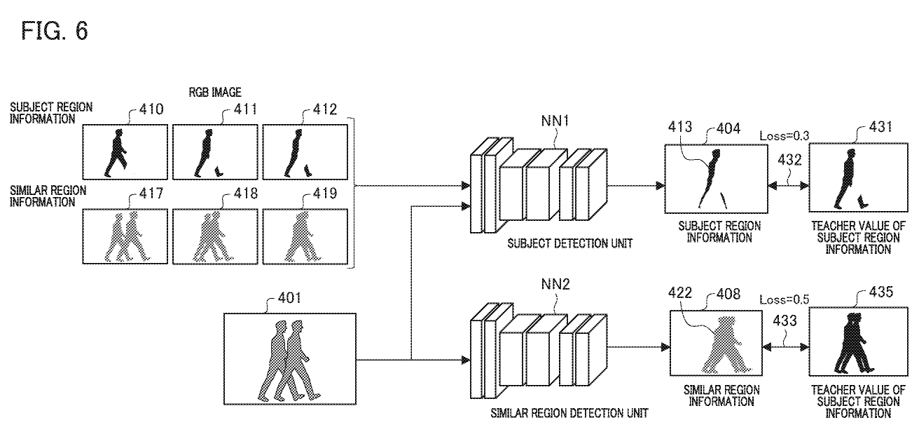

Next, a method of causing learning in the subject detection unit and the similar region detection unit will be explained with reference to FIG. 6.

FIG. 6 is a diagram for explaining the flow of processing of learning related to a subject region and a similar region associated with a tracking subject of the image processing apparatus according to the first embodiment.

A learning method of the subject detection unit 102 is as follows.

Neural network NN1 described in Chieh Chen et al. and the like outputs a map 404 of the subject region information based on three types of information. One type of information is an RGB image 401, which is an input image prepared for learning (hereinafter referred to as a “learning image”), and the others are subject region information 410, 411, and 412 of past frames, as well as similar region information 417, 418, and 419. Although Liang-Chieh Chen et al. and the like disclose a method for estimating a foreground region of an object belonging to a specific category, in this case, learning of NN1 is performed so that a map similar to a teacher value 431 of a subject region is obtained through estimation by providing the teacher value 431 of the subject region. As the teacher value of the subject region, in a case in which the subject is a person, information indicating a region of the entire body of a person, or information indicating a region of the same attribute (category), such as a part of the body, is provided, and learning is performed. As information indicating a region of an entire body of a person, for example, a map in which a value of 1 is assigned to a region including a head, a torso, and limbs, and a value of 0 is assigned to other regions such as a background, is used. However, in a case in which the information indicates a region, it is not limited to values of 0 and 1. Specifically, the output result map 404 is compared to the teacher value 431, and a loss value calculation 432 is performed by a known method such as cross- entropy or a squared error. The weight parameter of the neural network NN1 is adjusted by an error back propagation method and the like so that a loss value gradually decreases. (For this processing, a method similar to that of Liang-Chieh Chen et al. can be used.) The learning images and teacher values need to be provided in sufficient amounts for the learning to be effective. Since generating a teacher value for a region of overlapping objects is costly, it is also conceivable to generate learning data by using CG or by employing an image composition method in which object images are clipped and superimposed.

In contrast, a learning method of the similar region detection unit 103 is as follows.

A neural network NN2 described in Liang-Chieh Chen et al. and the like outputs the similar region information 422 based on the RGB image 401, which is a learning image. In a case in which a tracking subject is a person, a region belonging to a person category is defined as a teacher value 435. In this case, the teacher value 435 for the region belonging to the person category is set to include the teacher value 431 of the subject region. As a result, the similar region detection unit 103 is trained so as to respond to regions that are likely to represent persons. In addition, it is also conceivable to provide the teacher value 435 so as to represent a part of a target object, as long as the region has features similar to those of the tracking subject. Learning of the neural network NN2 is performed by using the teacher value 435. Specifically, an output result map 408 is compared to the teacher value 435, and a loss value calculation 432 is performed by a known method such as cross-entropy or a squared error. A weight parameter of the neural network NN2 is adjusted by an error back propagation method and the like so that the loss value gradually decreases. By including the teacher value 431 of the subject detection unit 102 in the teacher value 435 of the similar region information, it becomes unnecessary to provide the similar region detection unit 103 with a template image or time-series information in advance to specify the tracking subject. Therefore, since the similar region detection unit 103 can be trained to solve a recognition problem such as that described by Liang-Chieh Chen et al., the efficiency of learning is improved.

As described above, according to the present embodiment, it is sufficient that the similar region detection unit 103 be trained to find a region having person-likeness similar to a person serving as a tracking subject, and this corresponds to solving a semantic segmentation problem such as that described by Liang-Chieh Chen et al. Therefore, it is not necessary to identify features for each instance, and an effect of stabilizing the learning can be obtained.

Additionally, the subject detection unit 102, which detects a tracking subject, can perform processing with fewer computational resources than a method in which region information is fed back by labeling on a per-instance basis, as described by Yuanyou Xu et al. In a case in which the region information and the similar region information are each represented as a one-channel map for each frame, as compared to Yuanyou Xu et al., which discloses information having a number of channels corresponding to the number of object IDs, it becomes possible to detect a tracking subject under conditions using a still smaller amount of information. Therefore, the image processing apparatus according to the present embodiment can achieve both efficient use of computational resources and improvement in accuracy.

### Second Embodiment

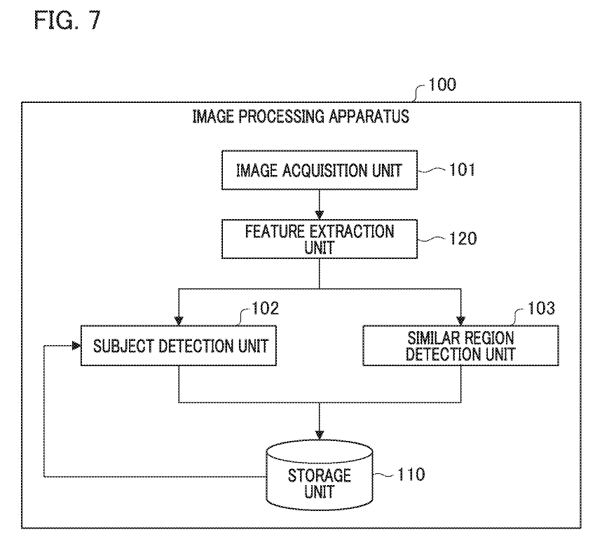

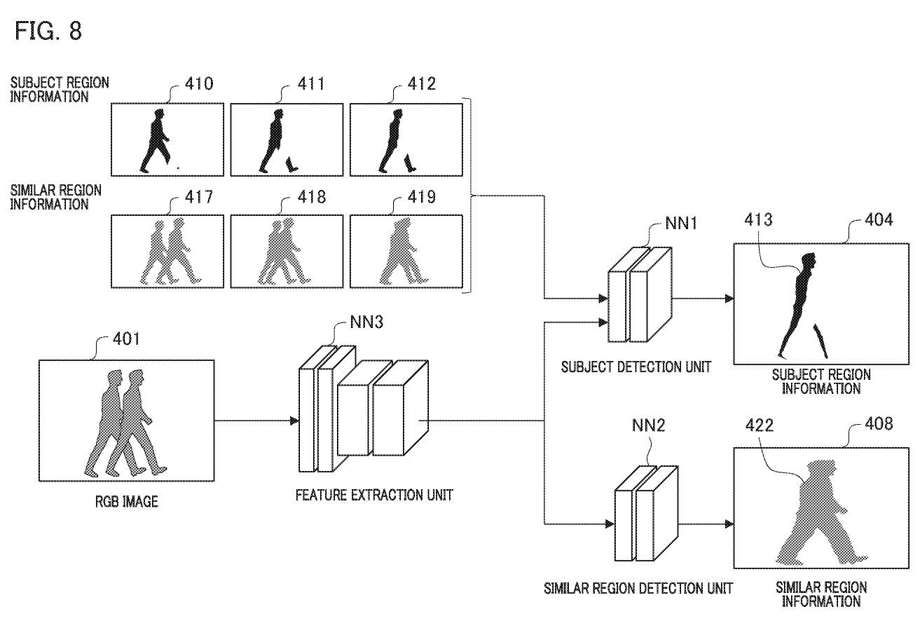

Hereinafter, the second embodiment according to the present disclosure will be explained with reference to FIG. 7 and FIG. 8.

In the present embodiment, a function of extracting feature quantities from an image is added to the image processing apparatus of the first embodiment so as to perform detection of a tracking subject and detection of a similar region thereof. In the present embodiment, explanation is given focusing on points that differ from those in the first embodiment.

First, a configuration of the image processing apparatus according to the second embodiment will be explained with reference to FIG. 7.

FIG. 7 is a functional configuration diagram of the image processing apparatus according to the second embodiment.

As shown in FIG. 7, the image processing apparatus 100 according to the second embodiment includes a feature extraction unit 120, in addition to the functional configuration of the first embodiment. The feature extraction unit 120 is a functional unit that calculates image feature quantities based on the RGB image 401.

Next, a flow of processing related to a subject region and a similar region associated with a tracking subject of the image processing apparatus will be explained with reference to FIG. 8.

FIG. 8 is a diagram for explaining a flow of processing related to a subject region and a similar region associated with a tracking subject of the image processing apparatus according to the second embodiment.

As shown in FIG. 8, the similar region detection unit 103 according to the present embodiment calculates the similar region information 422 described in the first embodiment based on image feature quantities extracted by the feature extraction unit 120 from the RGB image 401. In contrast, the subject detection unit 102 calculates the subject region information based on the feature quantities calculated by the feature extraction unit 120 and on the subject region information 410, 411, and 412 and the similar region information 417, 418, and 419 calculated from past frames.

In an initial frame in which the subject region information and the similar region information cannot be obtained in advance, initial subject region information and initial similar region information are calculated in a manner similar to the first embodiment, and are input to the subject detection unit 102 together with the feature quantities.

The feature extraction unit 120 is configured by a neural network NN3. Learning of the feature extraction unit 120 is performed for the neural network NN3 shown in FIG. 8 by using the teacher value 431 of the subject region information and the teacher value 435 of the similar region information in FIG. 6, in a manner similar to the loss values used for learning in the first embodiment. Although in the First Embodiment, the subject detection unit 102 and the similar region detection unit 103 calculated loss values separately, in the present embodiment, the loss values are calculated simultaneously and learning is performed. As a result, the feature extraction unit 120 is trained to extract image feature quantities that includes information related to both the subject region information and the similar region information. In a case in which loss values are calculated simultaneously, the two types of loss values are weighted and added, and a weight parameter of the neural network NN3 is adjusted by an error back propagation method and the like so that the added loss value gradually decreases. The first type of loss value is a loss value obtained between subject region information output by the subject detection unit 102 and a teacher value, and the second type of loss value is a loss value obtained between similar region information output by the similar region detection unit 103 and a teacher value. In addition to performing the calculation simultaneously, there is also a method in which learning is performed alternately for each iteration.

As described above, according to the present embodiment, both subject region information and similar region information can be calculated based on image feature quantities calculated by the same feature extraction unit 120, and the amount of calculation can be reduced. Furthermore, in learning of the subject detection unit 102 and the similar region detection unit 103, since learning can be performed simultaneously or alternately (end-to-end) by using each loss value, learning can be performed more efficiently.

### Third Embodiment

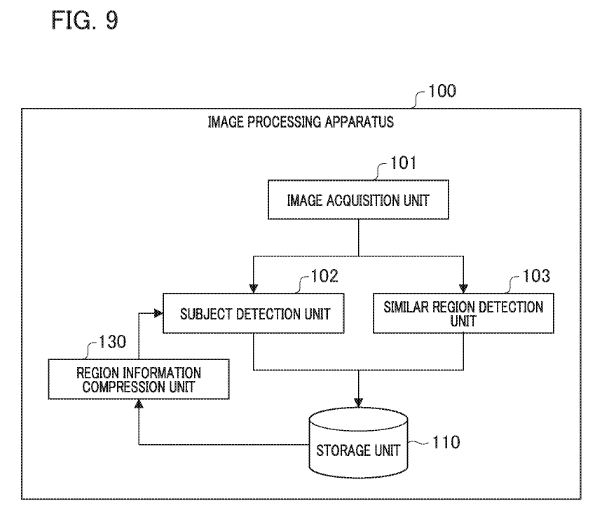

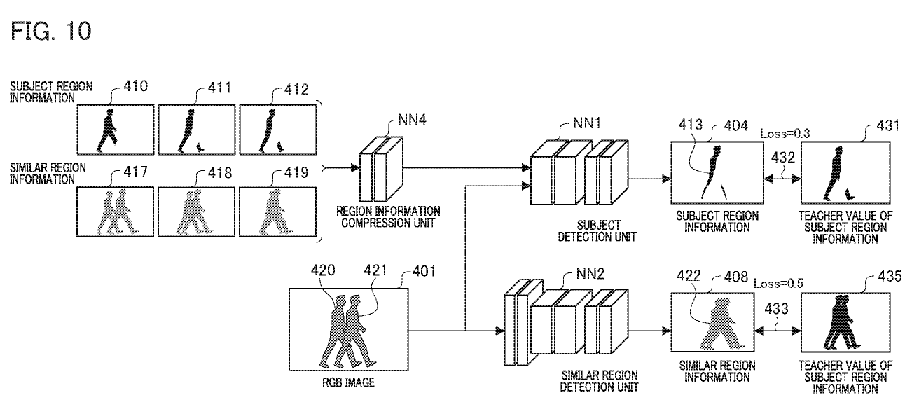

Hereinafter, the third embodiment according to the present disclosure will be explained with reference to FIG. 9 and FIG. 10.

In the present embodiment, a function of converting the subject region information and the similar region information of a tracking subject into data-compressed information is added to the image processing apparatus of the first embodiment so as to perform detection of a tracking subject and detection of a similar region thereof. In the present embodiment as well, the explanation will focus on differences from the first embodiment.

First, a configuration of the image processing apparatus according to the third embodiment will be explained with reference to FIG. 9.

FIG. 9 is a functional configuration diagram of the image processing apparatus according to the third embodiment.

As shown in FIG. 9, the image processing apparatus 100 according to the third embodiment has a region information compression unit 130, in addition to the functional configuration of the first embodiment. The region information compression unit 130 is a functional unit that converts subject region information and similar region information into data- compressed information.

Next, a flow of processing related to a subject region and a similar region associated with a tracking subject of the image processing apparatus will be explained with reference to FIG. 10.

FIG. 10 is a diagram for explaining a flow of processing of learning related to a subject region and a similar region with respect to a tracking subject of the image processing apparatus according to the third embodiment.

Processing in which the subject detection unit 102 and the similar region detection unit 103 calculate subject region information and similar region information by using the RGB image 401 as input is performed, in a similar manner to the first embodiment, by a neural network NN1 and a neural network NN2.

In the present embodiment, subject region information and similar region information calculated based on past frames are further converted by using a neural network NN4 that converts them into features having a smaller amount of information. Based on the subject region information and the similar region information, respective subject information and similar information are calculated by the neural network NN4. Subsequently, the subject information and the similar information are respectively input to the neural network NN1 of the subject detection unit 102 and are used to calculate the subject region information 413. As the subject information and the similar information, for example, a tensor of 1×1×C having a size smaller than the width and height of the subject region information and the similar region information is used. The tensor represents arbitrary values acquired through optimization by learning with a neural network. The number of dimensions C of the converted features is smaller than an area of the subject region information and an area of the similar region information. By setting the number of dimensions C to be sufficiently small, even when the total computational amount obtained by adding the computational amounts of the neural network NN4 and the neural network NN1 of the subject detection unit 102 from the input layer and subsequent layers is taken into consideration, the total amount of computation can be reduced as compared to a case in which the subject region information and the similar region information are directly input. As a result, the total amount of computation of the neural networks NN1, NN2, and NN4 can be suppressed to be smaller than in the first embodiment.

As the subject information and the similar information, for example, features in which a width and a height of the subject region information are halved may be used, or features in which the width and the height are 1 and a plurality of elements are arranged in a channel direction may be used. Learning of the neural network NN4 is performed by preparing teacher values 431 and 435 of the subject region information and the similar region information corresponding to past frames that have been prepared in advance for N frames, and by inputting them. Then, the subject information and the similar information thus calculated are input, together with the RGB image 401, to the neural network NN1 of the subject detection unit 102, and a loss value is obtained by using the subject region information thus calculated and the teacher value 431 of the subject region information. A method for updating parameters of the neural network NN4 using such a loss value is similar to that of the subject detection unit 102 described in the first embodiment.

As described above, according to the present embodiment, the subject region information and the similar region information in the first embodiment can be handled with an even smaller amount of information, and the amount of computation in the subject detection unit 102 can be reduced. Furthermore, since the subject detection unit 102 and the region information compression unit 130 can be learned simultaneously or alternately (end-to-end) by using respective loss values, it becomes possible to perform learning in such a manner that information relating to a region of a tracking subject and information relating to a region similar to the tracking subject can be converted more efficiently.

### Fourth Embodiment

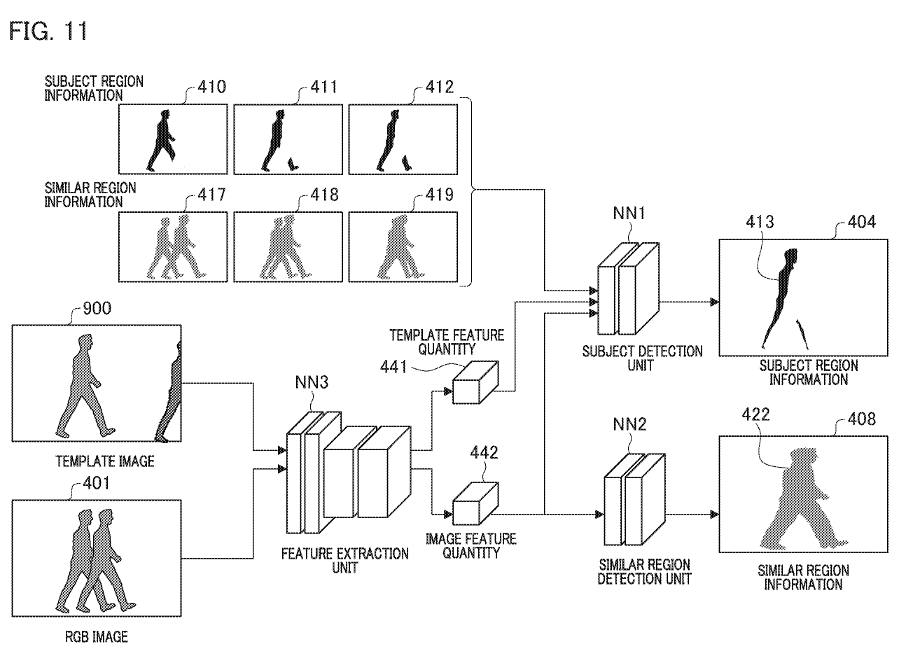

Hereinafter, the fourth embodiment according to the present disclosure will be explained with reference to FIG. 11.

In the second embodiment, explanation is given of an image processing apparatus that inputs an RGB image to a neural network that performs feature extraction, performs learning and inference, and performs tracking of a subject. The present embodiment is such that another image is further input to a neural network that performs feature extraction to calculate template feature quantities, and the template feature quantities are used for calculating subject region information and similar region information. In the present embodiment, explanation will focus on points different from the second embodiment.

Hereinafter, with reference to FIG. 11, a flow of processing related to a subject region and a similar region associated with a tracking subject of the image processing apparatus will be explained.

FIG. 11 is a diagram for explaining a flow of processing related to a subject region and a similar region associated with a tracking subject of the image processing apparatus according to the fourth embodiment.

In the present embodiment, a template feature quantity 441 and an image feature quantity 442 are newly calculated (feature extraction) by inputting an RGB image 440 (hereinafter referred to as a “template image”) obtained at a time different from the RGB image 401 to the neural network NN3 of the feature extraction unit 120. The RGB image 401, the subject region information 410, 411, and 412, and the similar region information 417, 418, and 419 calculated from past frames are input to the neural network NN1 of the subject detection unit 102 in a manner similar to the second embodiment described above. Furthermore, in the present embodiment, the template feature quantity 441 is also simultaneously input to the neural network NN1 of the subject detection unit 102. Then, the neural network NN1 calculates the subject region information 413 based on the template feature quantities, the subject region information, and the similar region information.

Learning of the feature extraction unit 120, the subject detection unit 102, and the similar region detection unit 103 is similar to that in the second embodiment. The image processing apparatus 100 simultaneously or alternately calculates subject region information by the subject detection unit 102 and similar region information by the similar region detection unit 103, and then calculates loss values by using the subject region information 413 and a teacher value of the subject region information 413, and the similar region information 422 and its teacher value, to perform learning. The weightings applied to the loss values and the learning method of the neural network are similar to those in the second embodiment.

As described above, according to the present embodiment, in a manner similar to the second embodiment, feature extraction for the same image is performed to calculate subject region information and similar region information, and the amount of computation can be reduced. Furthermore, by using a template image of a tracking subject, detection of the tracking subject can be realized while maintaining template features of a certain past frame. Therefore, an effect of being able to detect the tracking subject more robustly, as in the tracking method described in Luca Bertinetto et al. and the like, is obtained. As one example, a complicated state is considered in which another person overlaps the tracking subject in a sports scene such as soccer. In this case, a template image in which the tracking subject is shown in a non-crowded state is held in advance. Template feature quantities calculated from the held template image do not include features of a similar person, and therefore it becomes easy to capture features of only the tracking subject. In a case in which detection of the tracking subject is performed based on such template feature quantities, since features of another person (such as orientation, color, and the like) are not mixed, a risk of erroneously detecting an adjacent person as the tracking subject can be reduced. Thereby, more robust detection of the tracking subject can be realized.

According to the present disclosure, when tracking a specific subject in an image, it is possible to provide an image processing apparatus that can accurately track the subject while suppressing an amount of computation.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-6344, filed on January 16, 2025 , which is hereby incorporated by reference herein in its entirety.

What is claimed is:

1. An image processing apparatus comprising:
at least one processor; and
at least one memory having stored thereon instructions which, when executed by the at least one processor, cause the image processing apparatus at least to:
acquire input images in chronological order;
generate, from the input images, information related to a subject region of a tracking subject as subject region information;
generate, from the input images, information related to one or more similar regions of a subject similar to the tracking subject as similar region information;
store the subject region information and the similar region information; and
generate the subject region information by using the stored subject region information and the similar region information of past frames.

2. The image processing apparatus according to claim 1,
wherein a region of an attribute to which the tracking subject belongs is estimated, and the similar region information is generated so as to include a subject region of the tracking subject.

3. The image processing apparatus according to claim 1,
further comprising a feature extraction unit,
wherein image feature quantity to be extracted for generating the subject region information and image feature quantity to be extracted for generating the similar region information are extracted by the same feature extraction unit.

4. The image processing apparatus according to claim 1, wherein the subject region information or the similar region information is compressed and converted into region information of a smaller size, and the subject region information and the similar region information are generated based on compressed and converted region information.

5. The image processing apparatus according to claim 3, wherein the subject region information is calculated based on an image feature quantity obtained by the feature extraction unit based on an input image at a time different from a first input image, an image feature quantity obtained based on the first input image, the subject region information of past frames, and the similar region information of past frames.

6. The image processing apparatus according to claim 1, wherein generation of the subject region information and generation of the similar region information are performed by a neural network.

7. The image processing apparatus according to claim 3, wherein the feature extraction unit is configured by a neural network.

8. The image processing apparatus according to claim 4, wherein the conversion is performed by a neural network.

9. An image processing method for tracking a specific subject in an image by an image processing apparatus, the method comprising:
an input-image acquisition step of acquiring input images in chronological order by the image processing apparatus;
a subject detection step of generating, from the input images, information related to a subject region of a tracking subject as subject region information by the image processing apparatus;
a similar region detection step of generating, from the input images, information related to one or more similar regions that are regions of a subject similar to the tracking subject as similar region information by the image processing apparatus; and
a storage step of storing the subject region information and the similar region information by the image processing apparatus,
wherein, in the subject detection step, the subject region information is generated by using the stored subject region information and the similar region information of past frames.

10. A non-transitory computer-readable storage medium storing a computer program for causing a computer to execute each step in the control method of the image processing apparatus according to claim 9.
